(19) United States
(12) Patent Application Publication
(10) Pub. No.: US 2015/0100743 A1
(43) Pub. Date: Apr. 9, 2015

(54) SUPPORTING STORAGE OF DATA

(71) Applicant: Nokia Corporation, Espoo (FI)

(72) Inventors: Lauri Aarne Johannes Wirola, Tampere (FI); Tommi Antero Laine, Tampere (FI); Jari Syrjarinne, Tampere (FI)

(21) Appl. No.: 14/384,148

(22) PCT Filed: Mar. 15, 2012
(86) PCT No.: PCT/IB2012/051227

§ 371 Date: Nov. 16, 2014

(51) Int. Cl. G01S 5/02; G06F 12/02

(52) U.S. Cl. CPC G01S 5/02; G06F 12/023
USPC 711/154

(57) ABSTRACT

An apparatus determines at least one factor defining a density of an adaptive grid in relation to a density of a reference grid, while the adaptive grid is being used as a basis for storing data relating to a node of a communications network with a mapping to grid points of the adaptive grid. The apparatus causes storage of an indication of the determined at least one factor for the node.

### FIELD OF THE DISCLOSURE

The invention relates to the field of storage of data, and more specifically to supporting storage of data for a node of a communication network that are mapped to grid points of a grid.

### BACKGROUND

Data may be stored with a mapping to grid points of a grid for instance in order to reflect the applicability of different pieces of data for different locations, while enabling at the same time a limitation of the total amount of data that has to be stored.

For example, modern global cellular and non-cellular positioning technologies are based on generating large global databases containing information on cellular and non-cellular signals. The information may originate entirely or partially from users of these positioning technologies.

The information provided by users is typically in the form of “fingerprints”, which contain a location that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pahtlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points, the service set identifier (SSID) of the access points, and the signal strength of received signals (received signal strength indication RSSI or physical Rx level in dBm with a reference value of 1 mW, etc.).

This data may then be transferred to a server or cloud, where various radio models may be generated for positioning purposes. In the end, these refined radio models may be transferred back to user terminals for use in position determination.

The data received at the server has to be stored in order to be usable for refinement into further models. Such further models can be coverage area estimates or base station position and radio channel models.

A radio channel model may consists of a base station position and a pathloss model, or a plurality of pathloss models in the case of sectorized models, the base station being an exemplary node of a communication network. Before the model can be calculated, a certain amount of data including measurement results has to be collected within the coverage area of the base station. In a community-based collection effort, data need to be accumulated over time in order to obtain a sufficient amount of data.

It would be possible to store the measurement results and the associated locations as received. Alternatively, the received measurement results could be associated with grid points of a grid that represent locations close to the respective measuring position, in order to reduce the storage requirements.

### SUMMARY OF SOME EMBODIMENTS OF THE INVENTION

A method is described, which comprises at an apparatus determining at least one factor defining a density of an adaptive grid in relation to a density of a reference grid, while the adaptive grid is being used as a basis for storing data relating to a node of a communications network with a mapping to grid points of the adaptive grid. The method further comprises causing storage of an indication of the determined at least one factor for the node.

Moreover a first apparatus is described, which comprises means for realizing the actions of the presented method.

The means of this apparatus can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

Moreover a second apparatus is described, which comprises at least one processor and at least one memory including computer program code, the at least one memory and the computer program code configured to, with the at least one processor, cause an apparatus at least to perform the actions of the presented method.

Moreover a non-transitory computer readable storage medium is described, in which computer program code is stored. The computer program code causes an apparatus to realize the actions of the presented method when executed by a processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the computer program code by itself has to be considered an embodiment of the invention.

Any of the described apparatuses may comprise only the indicated components or one or more additional components.

Any of the described apparatuses may be a module or a component for a device, for example a chip. Alternatively, any of the described apparatuses may be a device, for instance a server or a mobile terminal.

In one embodiment, the described methods are information providing methods, and the described first apparatus is an information providing apparatus. In one embodiment, the means of the described first apparatus are processing means.

In certain embodiments of the described methods, the methods are methods for supporting storage of data with a mapping to grid points of a grid. In certain embodiments of the described apparatuses, the apparatuses are apparatuses for supporting storage of data with a mapping to grid points of a grid.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an apparatus according to an exemplary embodiment of the invention;

FIG. 2 is a flow chart illustrating a method according to an exemplary embodiment of the invention;

FIG. 3 is a schematic block diagram of a system according to an exemplary embodiment of the invention;

FIG. 4 is a diagram illustrating an exemplary movement of mobile terminals in the system of FIG. 3;

FIG. 5 is a diagram illustrating an exemplary grid and exemplary hop factors;

FIG. 6 is a diagram illustrating possible indices of grid points of the grid of FIG. 5;

FIG. 7 is a flow chart illustrating an exemplary operation in the system of FIG. 3;

FIG. 8 is a diagram illustrating a reduction of density of an exemplary adaptive grid;

FIG. 9 is a diagram illustrating an alignment between adaptive grids;

FIG. 10 is a diagram illustrating a misalignment between adaptive grids; and

FIG. 11 is a flow chart illustrating a further operation in the system of FIG. 3.

### DETAILED DESCRIPTION OF THE FIGURES

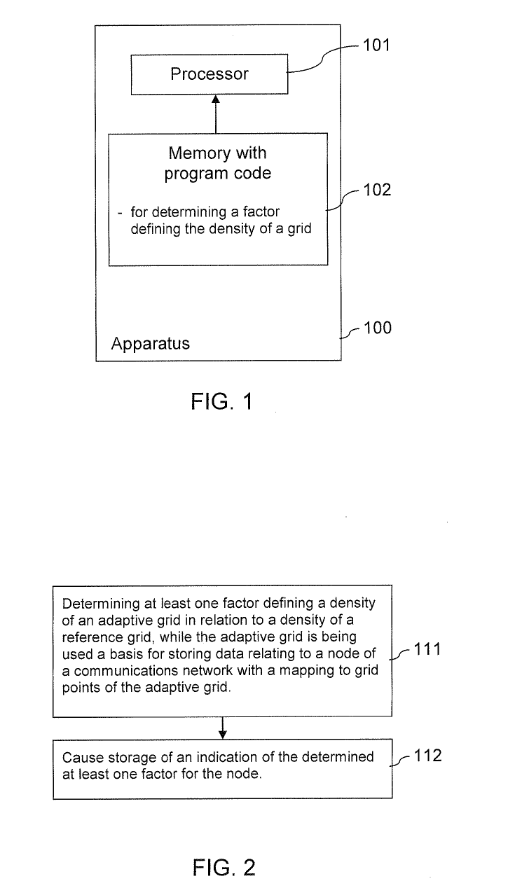

FIG. 1 is a schematic block diagram of an apparatus 100. Apparatus 100 comprises a processor 101 and, linked to processor 101, a memory 102. Memory 102 stores computer program code for determining a factor defining the density of a grid. Processor 101 is configured to execute computer program code stored in memory 102 in order to cause an apparatus to perform desired actions.

Apparatus 100 could be a server or any other device, for instance a mobile terminal. Apparatus 100 could equally be a module for a server or for any other device, like an encoder, a codec, a chip, circuitry on a chip or a plug-in board. Apparatus 100 is an exemplary embodiment of any apparatus according to the invention. Optionally, apparatus 100 could have various other components, like a data interface, a user interface, a further memory, a further processor, etc.

An operation of apparatus 100 will now be described with reference to the flow chart of FIG. 2. The operation is an exemplary embodiment of a method according to the invention. Processor 101 and the program code stored in memory 102 cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus determines at least one factor defining a density of an adaptive grid in relation to a density of a reference grid, while the adaptive grid is being used as a basis for storing data relating to a node of a communications network with a mapping to grid points of the adaptive grid. (action 111)

The apparatus furthermore causes storage of an indication of the determined at least one factor for the node. (action 112) That is, the indication can be stored in an apparatus that is caused by processor 101 to cause the storage, or in any apparatus.

Certain embodiments of the invention may thus enable an apparatus to support the use of an adaptive grid. The grid may be adaptive with respect to its density, and the density may be defined by a factor compared to the density of a reference grid. The factor may be determined not only once before starting to associate data with grid points of the adaptive grid. Rather, the factor can be determined anew whenever a predetermined condition is met, while the adaptive grid is already in use as a basis for storing data. By storing an indication of the determined factor for the node, it is always possible to determine the current density of the adaptive grid for correctly associating data to grid points of the adaptive grid, whenever new data is to be stored for the node, and for making use of stored data.

Certain embodiments of the invention may thus have the effect that the density of the grid and thus the amount of stored data can be adapted flexibly as needed.

Apparatus 100 illustrated in FIG. 1 and the operation illustrated in FIG. 2 may be implemented and refined in various ways.

The node could be a node of a cellular communication system, for instance a global system for mobile communications (GSM), a 3rd Generation Partnership Project (3GPP) based cellular system like a wide-band code division multiple access (WCDMA) system or a time division synchronous CDMA (TD-SCDMA) system, a 3GPP2 system like a CDMA2000 system, a long term evolution (LTE) or LTE-Advanced system, or any other type of cellular system, like a worldwide interoperability for microwave access (WiMAX) system. Alternatively, the node could be for example a node of a non-cellular communication system, like WLAN, Bluetooth and Zigbee, etc. The node of a cellular communication system could be for instance a transceiver or a base station of the cellular communication system. In general, a node of a cellular communication system could be an entity serving exactly one cell, or an entity serving a plurality of cells from a single position. The node of a WLAN could be a WLAN access point.

It is to be understood that at least one factor could be determined for each of various nodes of a single communication network or for each of various nodes of several communication networks.

It is further to be understood that a single factor or a single set of factors could be determined and stored for a particular node, or that several factors or several sets of factors could be determined and stored for a particular node. For instance, if a single node serves various cells of a cellular communication system, a separate factor or a separate set of factors could be determined and stored for any of these cells, each factor or set of factors indicating the density of an adaptive grid for another cell. Furthermore, one or more factors for a single adaptive grid or one or more factors for each of a plurality of adaptive grids could be determined and stored for a respective cell. Different grids could be associated for instance with different portions of an area in which signals of the cell can be observed.

The node could be identified for instance by means of an identifier of the node or by means of an identifier of a cell served by the node.

The data could be for instance data that are received from mobile terminals. They could comprise for instance results of measurements on signals from the node that are received by mobile terminals at different locations. It could also comprise other data, for instance the frequency at which data that can be associated to a respective grid point are received. The selection of the at least one factor could be based on the data for the node that is available so far.

In an exemplary embodiment of the invention, the density of the adaptive grid that is defined by the determined factor may be obtained in various ways. The previous density of the adaptive grid may be increased by adding columns and/or rows to the adaptive grid. Alternatively or in addition, the previous density of the adaptive grid may be increased by adjusting indices of grid points of the adaptive grid for which data is stored. If the data is stored in a two-dimensional table corresponding to the grid, the indices may change automatically when adding rows and/or columns. If the data is not stored in a table, but rather simply stored together with the indices of the respectively associated grid point, the indices may have to be changed actively. Furthermore, the previous density of the adaptive grid may be reduced by removing rows and/or columns of the adaptive grid. Alternatively or in addition, the previous density of the adaptive grid may be reduced by adjusting indices of grid points of the adaptive grid for which data is stored. Again, if the data is stored in a table corresponding to the grid, the indices may change automatically when removing rows and/or columns. If the data is not stored in a table, but rather simply stored together with the indices of the respective associated grid point, the indices may have to be changed actively.

In an exemplary embodiment of the invention, it could be provided that any increase in density comprises adding a new row between all existing rows and/or adding a new column between all existing columns in one or more iterations. In an exemplary embodiment of the invention, it could be provided that any reduction of density comprises removing every second row and/or removing every second column in one or more iterations.

In an exemplary embodiment of the invention, the density of the adaptive grid that is defined by the determined factor may also be obtained taking into account a configuration, in particular, though not exclusively, for obtaining an initial density.

There may be different criteria for starting a determination of a new factor. In an exemplary embodiment of the invention, determining the at least one factor comprises determining the at least one factor repeatedly, for instance periodically, after receipt of new data for the node, and/or after receipt of a predetermined amount of new data for the node or for a plurality of nodes. Determining the at least one factor periodically or after receipt of a predetermined amount of new data may have the effect that the processing load for adapting the grid or grids may be reduced compared to determining the at least one factor after each receipt of new data for the node. Determining the at least one factor periodically or after receipt of a predetermined amount of new data for various nodes may have the effect that only a single criterion has to be monitored for various nodes. Alternatively or as an additional criterion, the at least one factor could be determined after a detected change of storage consumption. It is to be understood that the latter criterion also covers a detected change of remaining storage space.

In an exemplary embodiment of the invention, the at least one factor is determined based on a currently used storage space. The considered storage space may be for instance exclusively the storage space that is used for storing data with a mapping to grid points of a grid for a particular node or cell, the storage space that is used for storing data with a mapping to grid points of a grid for all supported nodes, the storage space that is used for some more comprehensive kind of data, or the storage space that is used in general in a particular memory. The at least one factor may be determined to obtain a higher density if the current storage consumption is relatively low and may be increased, and to obtain a lower density if the current storage consumption is high and has to be reduced. This may have the effect that the used storage space can be limited. Frequently, but not necessarily, this may further have the effect that data for more grid points per area, i.e. higher grid density, can be stored when data is available for a small range compared to when data is available for a large range. Nevertheless, the total amount of grid points could be the same, larger or smaller for a small range compared to a large range.

It is to be understood that instead of the current storage consumption, also the remaining free storage space could be considered as a basis for determining the at least one factor.

Alternatively or in addition, the at least one factor could be determined based on an indication in a configuration. The configuration could include for instance a default factor or factors, or a value allowing deriving such factor or factors. The configuration could be fixed or variable.

In an exemplary embodiment of the invention, the at least one factor comprises at least one hop factor. A hop factor may define the number of rows of the reference grid per row of the adaptive grid and/or the number of columns of the reference grid per column of the adaptive grid.

It is to be understood that there could be the same or a different hop factor for columns and rows of an adaptive grid.

In an exemplary embodiment of the invention, the at least one hop factor may be a power of two. This may have the effect that a particularly efficient adaptation of the adaptive grid is enabled. It is to be understood, however, that in alternative embodiments the hop factor could take any other value as well.

In an exemplary embodiment of the invention, the adaptive grid is aligned with the reference grid based on the determined at least one factor. This may have the effect that any adaptive grid to which the same factor has been assigned will comprise the same remaining grid points of the reference grid in any overlapping area. As a result, a combined consideration of a plurality of adaptive grids in a further processing of the stored data may be facilitated.

In an exemplary embodiment of the invention, data for the node may be received and the received data may be stored with a mapping to grid points of the adaptive grid, taking account of the stored indication of the determined factor.

The data may be provided for instance by mobile terminals, for example by communication terminals, like mobile phones, smart phones, laptops, tablet computers, etc. The data could comprise for instance the results of measurements on terrestrial radio signals from the nodes of a communication system determined or collected at the mobile terminals. Such measurements could comprise for instance signal strength measurements, pathloss measurements, timing advance measurements, round-trip-time measurements, etc.

In an exemplary embodiment of the invention, stored data for the node may be retrieved and be further processed taking account of the stored indication of the determined factor.

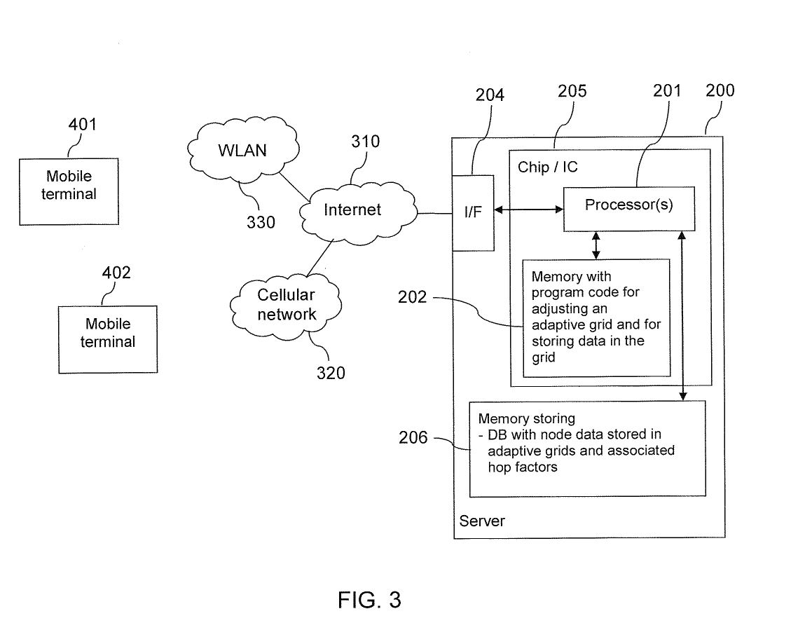

FIG. 3 is a schematic block diagram of a system comprising an exemplary embodiment of an apparatus according to the invention, which is configured to dynamically adjust adaptive grids.

The system comprises a server 200. Server 200 is connected to a network 310, for example the Internet. Server 200 could also belong to network 310. Network 310 is suited to interconnect server 200 with mobile terminals 401, 402 via a cellular network 320 or via any of a plurality of WLANs 330.

Server 200 may provide or support a learning system for building up and updating a positioning data learning database, for instance a fingerprint database. Server 200 may be for instance a dedicated positioning server, a dedicated position data learning server, or some other kind of server. It comprises a processor 201 that is linked to a first memory 202, to a second memory 206 and to an interface (I/F) 204. Processor 201 is configured to execute computer program code, including computer program code stored in memory 202, in order to cause server 200 to perform desired actions.

Memory 202 stores computer program code for dynamically adjusting an adaptive grid for a respective node of at least one communication network and for causing a storage of data based on the adaptive grids. The computer program code may comprise for example at least similar program code as memory 102. The program code could belong for instance to a comprehensive application supporting a learning of position data and/or supporting a positioning of mobile terminals. In addition, memory 202 may store computer program code implemented to realize other functions, as well as any kind of other data. It is to be understood, though, that program code for any other actions than adjusting adaptive grids could also be implemented on one or more other physical and/or virtual servers.

Processor 201 and memory 202 may optionally belong to a chip or an integrated circuit 205, which may comprise in addition various other components, for instance a further processor or memory.

Memory 206 stores at least one database that can be accessed by processor 201. The database is configured to store measurement data for nodes of cellular communication network 320 and for nodes of WLANs 330 on a per node basis. The data for each node is received successively from mobile terminals. In addition, memory 206 could store other data, for instance other data supporting a positioning of mobile terminals. It is to be understood that the memory storing the database could also be external to server 200; it could be for instance on another physical or virtual server.

Interface 204 is a component which enables server 200 to communicate with other devices, like mobile terminals 401 and 402, via network 310. Interface 204 could comprise for instance a TCP/IP socket.

Component 205 or server 200 could correspond to exemplary embodiments of an apparatus according to the invention.

Cellular communication network 320 comprises a plurality of transceivers operating as nodes of the network. Each WLAN 320 comprises at least one access point as a node of a communication network.

Mobile terminals 401, 402 may comprise a GNSS receiver enabling them to determine their own position based on satellite signals. Mobile terminals 401, 402 may further be configured to perform measurements on signals from nodes of cellular communication network 320 or WLANs 330, for example signal strength measurements. Further, they may be configured to report measurement results taken at different locations to server 200.

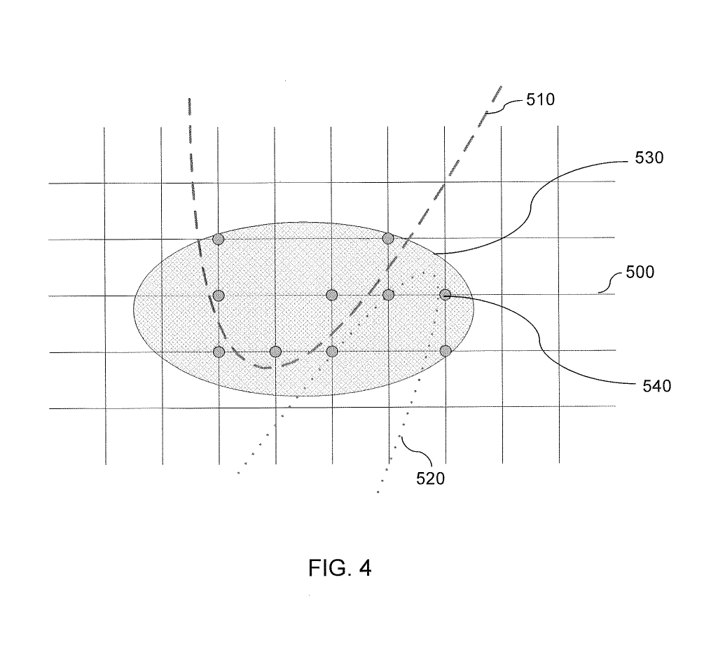

FIG. 4 illustrates for an exemplary node a virtual grid 500 covering a certain area of Earth, a first trajectory 510 of a first data collecting mobile terminal 401 in this area and a second trajectory 520 of a second data collecting mobile terminal 402 in this area. FIG. 4 further shows data represented by small circles 540. The data could comprise measurement results provided by mobile terminals 401 and 402 while moving along trajectories 510 and 520, respectively. The data may originate from arbitrary positions on trajectories 510 and 520, but have been mapped to certain grid points of the grid 500 in the coverage area 530 of the node, which reduces the storage requirements significantly. The coordinates of the grid points can be expressed in terms of grid indices relative to the grid origin. In memory, the grid can be represented simply as a two-dimensional table.

However, when data starts arriving for a given communication node, the size of the area that is served by the node is usually not yet known. For instance, in the case of GSM cells, the radius may range from 100 m to 35 km. Thus, when using a conventional static grid, it is necessary to store data at the maximum density specified for the network.

Now, if the area served by the communication node turns out to be large, it may be beneficial to reduce the density of the stored data and of the data that still is to be stored. When reducing the density of the data, the storage requirements as well as the computational requirements, for instance with respect to central processing unit (CPU) and memory, may decrease proportionally.

In fact, when the data is used for example for generating radio channel models, there may be practically no loss of modeling data, when reducing the grid density for large cells. To exemplify, in a cellular communication system, a microcell might have a range of 300 m and a macrocell might have a range of 30.000 m. Assuming that a radio modeling algorithm would require ten points to model the pathloss parameters, a 30 m data spacing would be adequate in the case of a microcell, while in the case of a macrocell the data density can be dropped significantly. It could be dropped for instance to 1/100 of the density that is obtained with the 30 m spacing, resulting in a 3000 m spacing. It has to be noted that as the grid density drops to 1/100 of the original density, the storage requirement decrease to 1/10,000.

The reason for the relation between the required grid density and the range of a node is that the bigger the cell is the longer the shadow fading de-correlation distance is. In practice, this means that the close-by samples are correlated and thus carry redundant information. Thus the longer the de-correlation distance is, the more redundant data there is in a tight grid. In conclusion the larger the cell, the sparser the grid can be.

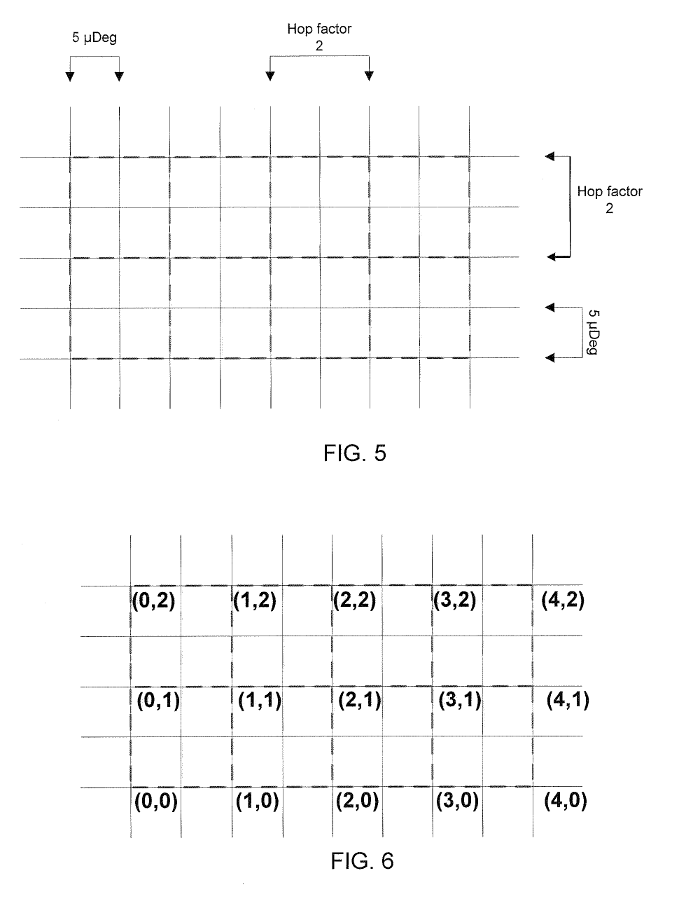

FIG. 5 now illustrates an adaptive grid by means of an example. The Earth surface is virtually divided into a grid having a grid spacing of ε μDeg in latitude and longitude directions. The value of c could be set for instance to 5. In latitude direction, this corresponds to 0.56 m along the equator at the equator, and to 0.28 m along the latitude circle at 60° latitude. The virtual grid functions as a reference grid, and it is shown in FIG. 6 with solid lines. The adaptive grid for any node is a proper subset of the reference grid, that is, no cell covers the whole Earth surface. A hop factor assigned to each adaptive grid allows for a grid density control. The hop factor defines the grid point density in the grid. The hop factors are powers of 2. To exemplify, in case the hop factor is 2, the adjacent grid points are spaced 2ε μDeg apart. An adaptive grid defined by a hop factor of 2, resulting in a spacing of 2ε=10 μDeg in latitude and longitude direction, is shown with dashed lines in FIG. 5.

When storing the data, it is only necessary to store the hop factor information and the indices of the grid points to which the data are mapped, that is, the relative coordinates. An exemplary assignment of such indices to grid points of an adaptive grid is illustrated in FIG. 6. When the data is needed again, the hop factor directly yields the spacing of the grid points. For example, when data is stored for grid point with indices (2,1) and the hop factor for the adaptive grid is 2, it is immediately apparent that the data is valid for a position shifted by 2*2*5 μDeg=20 μDeg in latitude direction and 2*1*5 μDeg=10 μDeg in longitude direction with respect to the origin of the adaptive grid. In other words, the same number of data points consumes the same amount of storage space regardless of the grid density.

It is to be understood that in an alternative embodiment, a first hop factor HF₁ could define the density of the adaptive grid in longitude direction, and a second hop factor HF₂ could define the density of the adaptive grid in latitude direction. For example, HF₁=2 could mean that data may be stored at every second grid point of the reference grid along latitude circle, resulting in a 10 μDeg grid size in longitude direction, and HF₂=8 could mean that data may be stored at every eighth grid point of the reference grid along the longitude circle, resulting in a 40 μDeg grid size in latitude direction.

The adaptive grid can, for instance, carry Rx level data measured by mobile terminals 401, 402 on signals received from a node when operating as a serving node for these mobile terminals 401, 402.

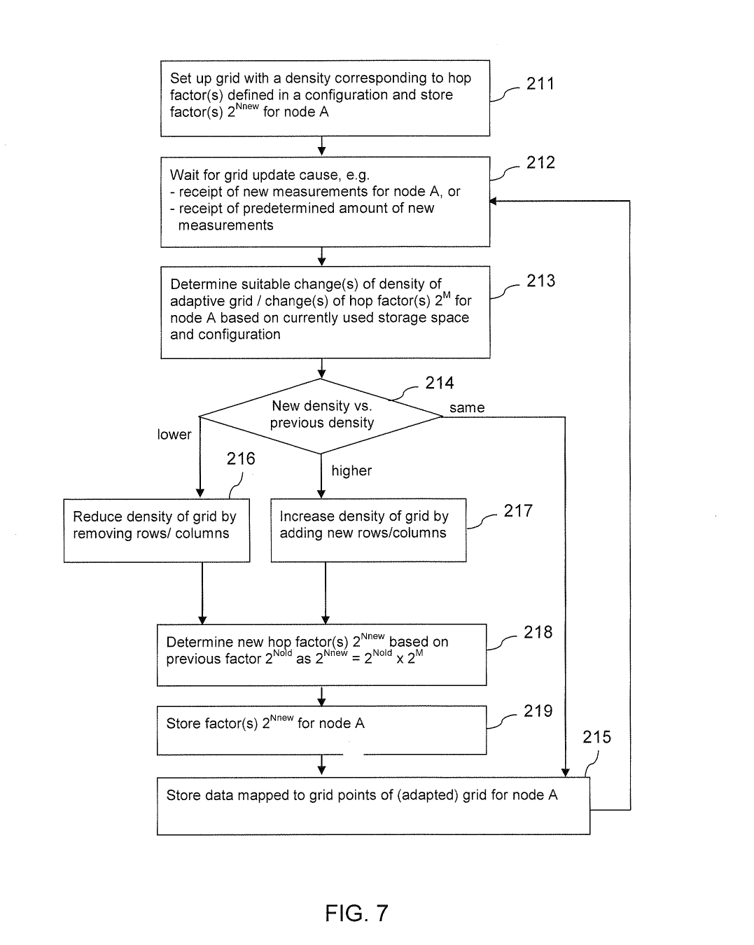

An exemplary operation at server 200 of the system of FIG. 3 will now be described with reference to the flow chart of FIG. 7. Processor 201 and the program code stored in memory 202 cause server 200 to perform the presented operations when the program code is retrieved from memory 202 and executed by processor 201.

At first, an adaptive grid is set up for a particular node A using a hop factor that is derived from an indication in a configuration. (action 211) An indication of the hop factor 2^{New} is stored in memory 206. The hop factor is a measure for the density of the adaptive grid compared to the density of the reference grid. The hop factor is generally a power of 2 in this embodiment. If the trigger for setting up an adaptive grid for node A is the receipt of first measurement results for node A, the measurement results are stored in memory 206 with a mapping to grid points of the adaptive grid taking account of the hop factor.

Server 200 then waits for the point of time at which the current density of the grid for node A, for which data is stored in the database of memory 206, is to be updated. (action 212) The update could be performed after each receipt of new measurement results for node A from a mobile terminal, or after receipt of a predetermined amount of new measurement results from mobile terminals for node A, or after receipt of a predetermined amount of new measurement results from mobile terminals for all nodes.

When a cause for an update is detected, server 200 determines a suitable change of density of the adaptive grid for node A based on the storage space currently used for node A. (action 213) Suitable changes of density could be associated to predetermined threshold values of the storage space. For instance, whenever the used storage space exceeds a first predetermined threshold value or whenever the remaining storage capacity falls short of a first predetermined threshold value, the density could be halved. Similarly, whenever the used storage space falls short of a second predetermined threshold value or whenever the remaining storage capacity exceeds a second predetermined threshold value, the density could be doubled. It is to be understood that also a plurality of threshold values could be set and monitored for increasing and/or reducing the density. For instance, whenever the used storage space exceeds a first predetermined threshold value the density could be halved, and whenever the used storage space exceeds a further predetermined threshold value the density could be quartered, etc. When selecting threshold values for the storage space, it has to be taken into account that a change of the density of the adaptive grid is reflected quadratically in the resulting change of the used storage space.

Determining a change of density is equivalent to determining a change of hop factor, since a change in density ½^{M} corresponds inversely proportional to a change in the hop factor 2^{M} compared to the previous hop factor. For instance, if the density was halved, this corresponds to a change of the hop factor by 2¹=2.

Alternatively, a suitable density could be determined for example computationally based on the currently used storage space; and a suitable change of density could then be determined based on the determined suitable density and a previously stored hop factor defining the current density of the adaptive grid.

If the density remains the same as the previous density (action 214), received data for node A is stored with a mapping to the grid points of the grid taking account of a previously stored hop factor. (action 215)

If the density is lower than the previous density (action 214), the density of the adaptive grid is reduced by removing rows and/or columns of the adaptive grid. (action 216) In this process, the currently stored data that is associated with the dropped rows and columns is removed. For facilitating the implementation, every second row and/or column may be removed in several iterations, starting from the previously stored grid, to obtain the new grid, in case the density is to be more than halved, for instance quartered.

If the density is higher than the previous density (action 214), in contrast, server 200 increases the density of the adaptive grid for node A by adding rows and/or and columns to the current grid. (action 217) For facilitating the implementation, an additional row and an additional column may be added after each row and each column in several iterations, starting from the previously stored grid, to obtain the new grid, in case the density is to be more than doubled, for instance quadrupled.

In case the density of the adaptive grid is changed (action 216, 217), server 200 moreover determines a new hop factor 2^{Nnew} for node A, before storing the data.

To this end, server 200 retrieves an indication of the previous hop factor, now referred to as 2^{Nold}, for node A, which is stored in memory 206. Then, a new hop factor 2^{Nnew} can be determined as 2^{Nnew}=2^{M}*2^{Nnew-Nold}. (action 218) The new hop factor is larger than the old hop factor, if the storage consumption had to be reduced, and smaller than the old hop factor, if the storage consumption may be increased. It is to be understood that the new hop factor could also be determined for instance before or in parallel to the adjustment of the density of the adaptive grid.

Server 200 now stores an indication of the new hop factor for node A in memory 206. (action 219) The stored indication of the hop factor may be for instance the value of the exponent Nnew of the hop factor 2^{Nnew}.

Then, the data is stored with a mapping to the grid points of the adapted grid. (action 215)

The data may be stored in various ways with a mapping to grid points of the adaptive grid. The grid could be represented for instance by a table that is stored in the database, and the data could be inserted as entries of the table. It is to be understood, however, that the storage of the data does not require storage of the entire grid or of an entire table. Since many grid points may not have any data associated with them so far, the data could be stored for instance efficiently using a run-length encoding. Further alternatively, the indices of the grid points, with which data are associated, followed by the respectively associated data could be stored in a sequence.

Finally, server 200 waits for the point of time at which the next update is to be performed. (action 212)

If the indication of a default hop factor in the parameters of the configuration is subject to changes, it could be taken into account in addition in action 213. For example, node A might have a hop factor of HF=2¹⁰, and the stored measurement data do not exceed the acceptable storage consumption for node A. However, if the indication of the default hop factor in the configuration is changed to HF=2¹², then although the currently stored data fit into the allowed storage space, the system may need to change the hop factor of the processed cell to HF=2¹². Conversely, if the indication of the default hop factor in the configuration is changed to HF=2⁶, then server 200 might attempt to lower the hop factor as far as possible within the limits of an acceptable storage consumption.

It is to be understood that in an alternative embodiment, server 200 could also determine and store separate hop factors for latitude and longitude direction for a single adaptive grid. This may have the effect that the spherical shape of the Earth can be taken into account. For instance, node A could at first have hop factors of HF₁=HF₂=8. That is, the grid spacing could be (2⁸)*5=1,280 μDeg. Now, assume that Node A is at 60 degree latitude. In this case, 1,280 μDeg corresponds to 142 meters in latitude direction, but only to 71 meters in longitude direction. Therefore, in a first step, only the density in longitude direction could be halved by using a new hop factor, and it could be monitored whether this is sufficient for reducing the storage space. This may prevent discarding more stored measurement results than necessary.

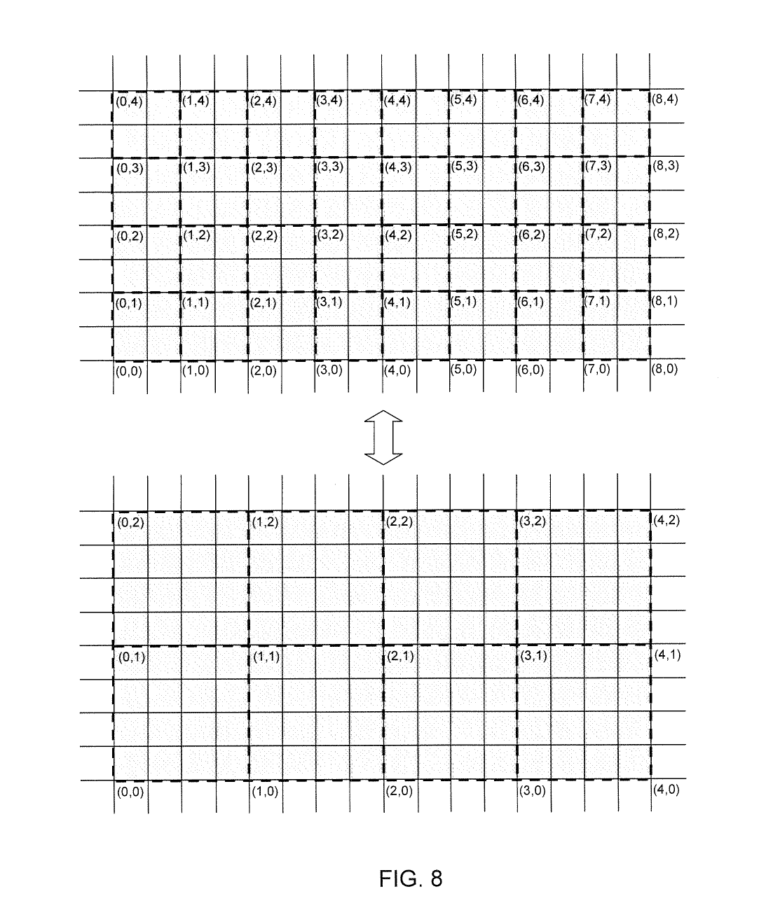

A process of reducing the density of an adaptive grid is illustrated in FIG. 8. FIG. 8 shows at the top an adaptive grid that has been the basis for storing data for node A before the update. FIG. 8 shows at the bottom an adaptive grid that is to be used as the basis for storing data for node A after the update. The adaptive grid is shown in both cases with dashed lines, while the reference grid in this area is shown with solid lines.

As can be seen in the upper part of FIG. 8, the old hop factor 2^{Nold} is 2¹=2; thus the adaptive grid comprises every second row and every second column of the reference grid in the selected area. The associated indices of the grid points range from (0,0) at the origin of the adaptive grid to (8,4).

The new hop factor may now be assumed to be selected as 2^{Nnew}=2²=4. Thus, for the new adaptive grid, every second row and every second column of the previous adaptive grid are removed. As a result, the stored data that are associated with the grid points in every second row and to the grid points in every second column is removed as well, i.e. the data that are associated with grid points with indices (Y,1) and (Y,3) with Y=0 . . . 8, and with grid points with indices (1,X), (3,X), (5,X) and (7,X), with X=0 . . . 4 is dropped. As a result, the amount of data for node A drops to approximately ¼ of the previously stored amount of data.

When removing columns and rows, also the indices of the adaptive grid change, as can be seen in the lower part of FIG. 8. In the indices of the remaining grid points with which data are associated, each index is divided by 2^{M}=2. The indices of the grid points now range from (0,0) at the origin to (4,2).

FIG. 8 also illustrates the effect of limiting the hop factors to powers of two. The process of reducing the density of an adaptive grid may be rather straightforward, when the process simply requires the removal of even rows and columns. If the hop factor is freely selectable, the up-scaling may be a more tedious task.

A process of increasing the density of an adaptive grid can be considered to be illustrated as well in FIG. 8, when considering the lower part of FIG. 8 to represent an old grid for node A that is based on a hop factor of 4, and the upper part of FIG. 8 to represent the new grid for node A that is based on a hop factor of 2. When the hop factor for the grid of node A changes from 4 to 2, the density of the grid for node A is increased by adding a respective new row between all existing rows, and by adding a respective new column between all existing columns of the old grid. The number of grid points increases approximately by a factor of four in the process.

FIG. 8 illustrates as well the effect of limiting the hop factors to powers of two when down-scaling the hop factor. It renders the process of down-scaling very simple, since it requires just an addition of (initially) empty rows/columns. Again, with hop factors that are freely selectable, the process is somewhat more demanding.

Nevertheless, it is to be understood that hop factors that are no power of two could be used as well in some alternative embodiment.

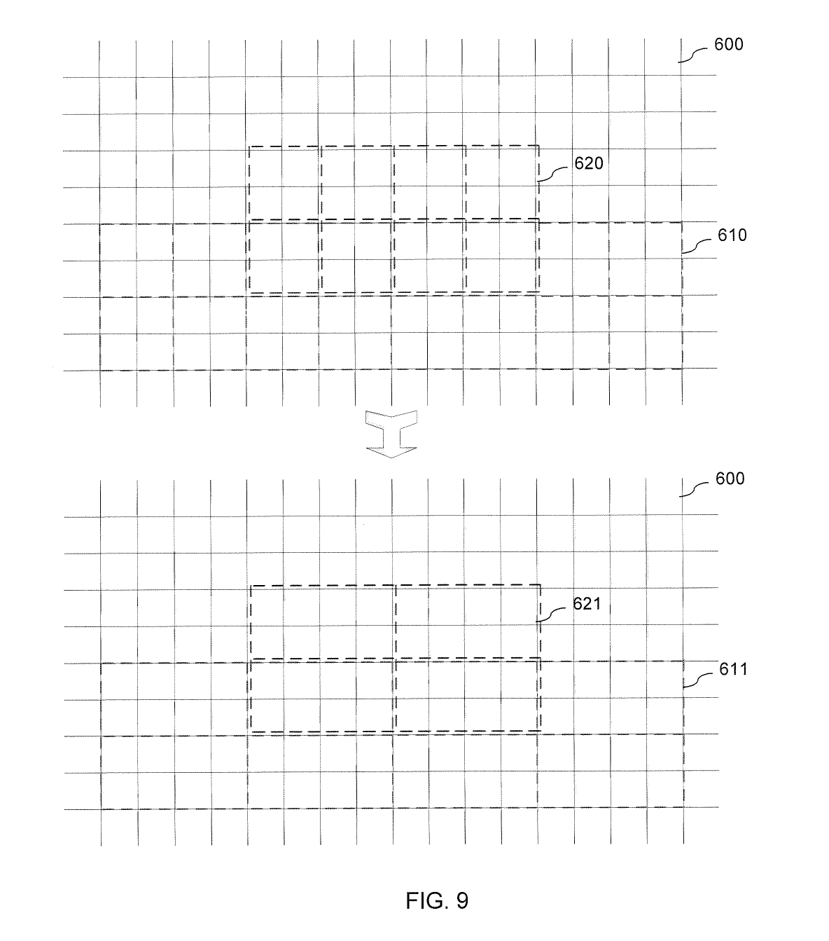

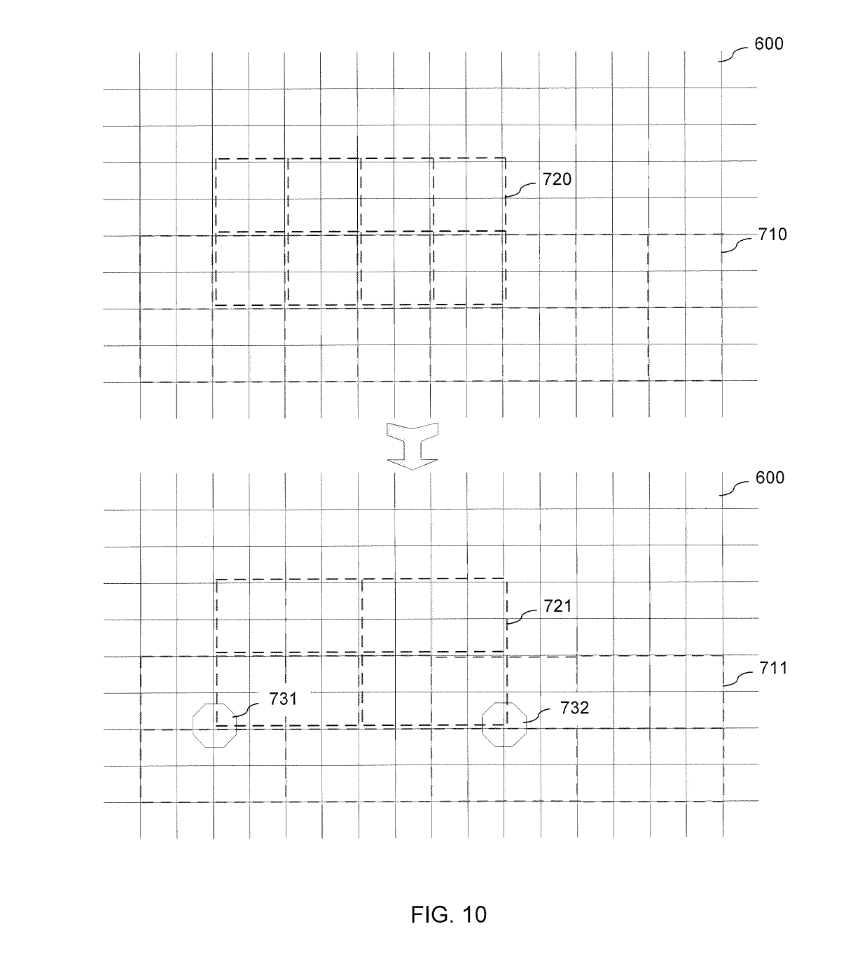

FIGS. 9 and 10 illustrate another aspect that may be taken into account by server 200 when adjusting the adaptive grid for a node in action 216, namely an alignment of the adaptive grid with the reference grid as a modulus of the hop factor. That is, the origin of each adaptive grid is always selected such that it can be reached from the origin of the reference grid by repeated hopping according to the hop factors in latitude and longitude direction. For instance, if the hop factor is 4 in latitude direction and 2 in longitude direction for a particular adaptive grid, the origin of the adaptive grid can be reached when moving from the origin by n*4 of the latitude grid spacing in latitude direction and by m*2 of the longitude grid spacing in longitude direction, with n and m being a natural number. This may have the effect the adaptive grids for all nodes for which data is stored in memory 206 are aligned to each other.

FIG. 9 shows in an upper part by way of example two adaptive grids 610, 620 in different places on a reference grid 600. The reference grid 600 is shown with solid lines, and the adaptive grids 610, 620 are shown with dashed lines. Both adaptive grids 610, 620 are based on a hop factor of 2 in both latitude and longitude directions. The origin of second grid 620 is located at the grid point with indices (2,1) of first grid 610. In the overlapping areas of first grid 610 and second grid 610, grids 610 and 620 comprise exclusively grid points at matching locations.

The grids 610 and 620 thus align perfectly, and this may be of advantage if the grid data is used in the context of conventional fingerprinting, using measurement results for signals from multiple communication nodes and comparing these to the data stored in the database. This requires that the positions, with which the measurement results are associated for storage, align, and thus that the used grids align.

The hop factor might then be changed to 4 in longitude direction for both adaptive grids, resulting in an adjusted first grid 611 and an adjusted second grid 621. Also grids 611 and 621 align perfectly, as can be seen in the lower part of FIG. 9.

FIG. 10 illustrates a second case. In the upper part, a first grid 710 is in the same location as the first grid 610 in the upper part of FIG. 9, but the origin of a second grid 720 now coincides with the grid point with indices (1,1) of first grid 710. Nevertheless, grids 710 and 720 are still aligned.

Now, the hop factors is changed again to 4 in longitude direction for both adaptive grids, resulting in first grid 711 and second grid 721, as illustrated in the lower part of FIG. 10. As can be seen, the grids 711 and 721 now misalign, which may make fingerprinting-based positioning impossible at certain points. These points are marked in FIG. 10 with hexagons 731 and 732.

For certain applications it may thus be of advantage to take care that the adaptive grids for all nodes align to the reference grid with the modulus of the hop factor of the adaptive grid, or with the modulus of the hop factors, in case those are different in the two directions.

Alternatively, it could be taken care in a situation as shown in the upper part of FIG. 10 that when changing the hop factor from 2 to 4 for the columns for the grid 720, every second column is removed in such a way that the first column to be removed is the first column with local coordinates (0,x) with x=1,2,3. In this manner the changed grids will coincide as well.

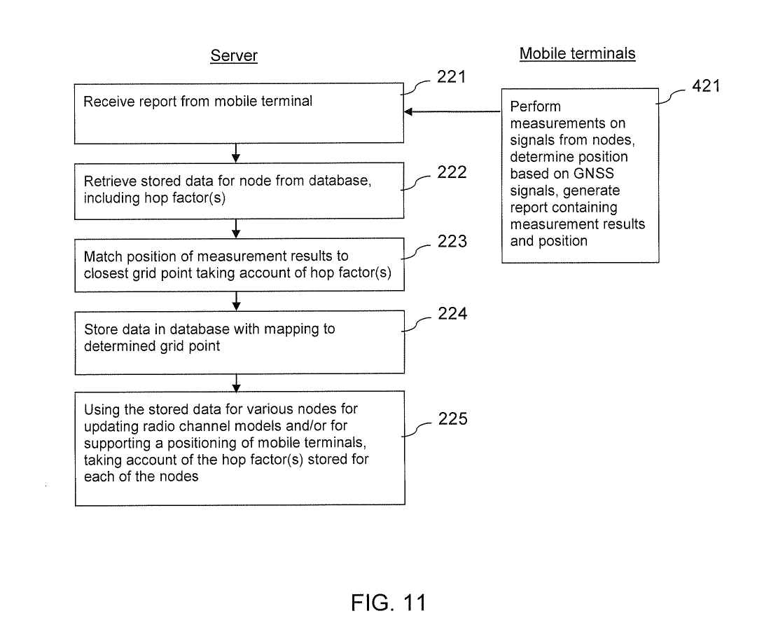

An exemplary operation of the system of FIG. 3 making use of the stored hop factors will now be described with reference to the flow chart of FIG. 11. Operations at server 200 are presented on the left hand side of FIG. 11. Processor 201 and the program code stored in memory 202 cause server 200 to perform the presented operations when the program code is retrieved from memory 202 and executed by processor 201. Operations at mobile terminals 401, 402 are presented on the right hand side of FIG. 11.

Mobile terminal 401 receives satellite signals and determines its current position. In addition, mobile terminal 401 detects signals transmitted by access points (AP) of one or more WLANs 330 and/or by one or more base stations of a cellular network 320. Mobile device 401 assembles results of measurements on these signals, and associates with the result or results for at least one node a direct or indirect identification of the node, for instance a cell identity of a serving cell or an identity of a currently accessed WLAN AP. Mobile device 401 then transmits the measurement results and the associated identification along with an indication of the determined position as a fingerprint to server 200. (action 421) The transmission may take place via WLAN 330 and network 310 or via cellular network 320 and network 310. It has to be noted that in an alternative embodiment, the position of mobile device 401 could also be determined based on some other positioning technology than GNSS. For instance, if mobile terminal 401 collects measurements on cellular radio signals for transmission to server 200, mobile terminal 401 could determine its position based on WLAN signals instead of GNSS signals.

Mobile terminal 401 may transmit measurement results for the same node from various locations while moving around. In addition, other mobile terminals that are attached to the same node, for instance mobile terminal 402, may transmit corresponding reports to server 200.

Server 200 receives a report with measurement results and an associated indication of a position from mobile terminal 401. (action 221)

Server 200 determines the identity of a node to which at least one of the measurement results relates, and retrieves stored data for this node from memory 206, if any. In addition, server 200 retrieves the current hop factor that is stored for the node in memory 206, if any. (action 222)

Next, server 200 matches the indicated position, at which the at least one measurement result has been collected, to a grid point of an adaptive grid, taking account of the hop factor. (action 223) If no data had been available so far for the node, a hop factor of 2⁰=1 is assumed, which corresponds to a grid having the same density as the reference grid and thus the maximum density. Alternatively, a default value may be used as an initial hop factor, for example 2⁴=16 or any other value. A dedicated default value may be provided per air interface type, that is, the default value could be different for WLAN, GSM, etc.

Server 200 then stores the measurement results in the database in memory 206 with a mapping to the determined grid point. (action 224)

The data in the database in memory 206 may be used for regularly updating further models, for example radio channel models, or directly for supporting a positioning of mobile terminals. (action 225) When retrieving the data for one or more nodes from memory 206 for such a purpose, the stored hop factors are taken into account again, for obtaining the correct spacing between grid points for the respective adaptive grid for each node.

It has to be noted that also mobile terminals with GNSS capability may benefit from using cellular/non-cellular positioning technologies, in order to accelerate the time-to-first-fix, using the obtained location as reference location, or in order to reduce the power consumption. Furthermore, not all applications require a GNSS based position. Furthermore, positioning technologies that are based on terrestrial radio signals may be better suited to work indoors than positioning technologies that are based on satellite signals.

It has to be understood that also a mobile terminal might benefit from an implementation using adaptive grids for storing data for different nodes. For instance, if a mobile terminal is provided specifically for measuring signals from nodes, it might collect a large number of samples for various nodes before providing the data to a server. In the meantime, the mobile terminal could map the data to grid points of an adaptive grid, store the mapped data in an internal memory, and update the adaptive grids for each node from time to time in a similar manner as described with reference to FIG. 7 for server 200.

Summarized, certain embodiments of the invention may thus have the effect of enabling a simple up- and down-scaling of the grid density as information on the range of a node accumulates. This may reduce the storage consumption when storing data for large range nodes, while supporting at the same time a high density of stored data for a node as long as the full range of the node is not yet known.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or 201 in combination with memory 102 or 202, respectively, or the integrated circuit 205 can also be viewed as means for determining at least one factor defining a density of an adaptive grid in relation to a density of a reference grid, while the adaptive grid is being used as a basis for storing data relating to a node of a communications network with a mapping to grid points of the adaptive grid; and as means for causing storage of an indication of the determined at least one factor for the node.

The program codes in memory 102 and 202, respectively, can also be viewed as comprising such means in the form of functional modules.

FIGS. 2 and 7 may also be understood to represent exemplary functional blocks of computer program codes for supporting storage of data mapped to grid points of a grid.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-24. (canceled)

25. A method comprising at an apparatus:
determining at least one factor defining a density of an adaptive grid in relation to a density of a reference grid, while the adaptive grid is being used as a basis for storing data relating to a node of a communications network with a mapping to grid points of the adaptive grid; and
causing storage of an indication of the determined at least one factor for the node.

26. The method according to claim 25, further comprising obtaining the density of the adaptive grid by one of:
taking into account a configuration;
increasing a previous density of the adaptive grid by adding at least one of columns and rows to the adaptive grid; and
reducing a previous density of the adaptive grid by removing at least one of rows and columns of the adaptive grid.

27. The method according to claim 25, wherein determining the at least one factor comprises determining the at least one factor at least one of
after a detected change of storage consumption;
after receipt of new data for the node; and
after receipt of a predetermined amount of new data.

28. The method according to claim 25, further comprising determining the at least one factor based on at least one of the current storage consumption and an indication in a configuration.

29. The method according to claim 25, wherein the at least one factor comprises at least one hop factor, which defines at least one of the number of rows of the reference grid per row of the adaptive grid and the number of columns of the reference grid per column of the adaptive grid.

30. The method according to claim 29, wherein the at least one hop factor is a power of two.

31. The method according to claim 25, further comprising aligning the adaptive grid with the reference grid based on the selected at least one factor.

32. The method according to claim 25, further comprising receiving data for the node and storing the received data with a mapping to grid points of the adaptive grid, taking account of the determined factor.

33. The method according to claim 25, further comprising retrieving data that is stored for the node with a mapping to grid points of the adaptive grid, and processing the data taking account of the determined factor.

34. An apparatus comprising at least one processor and at least one memory including computer program code, the at least one memory and the computer program code configured to, with the at least one processor, cause an apparatus at least to perform:
determine at least one factor defining a density of an adaptive grid in relation to a density of a reference grid, while the adaptive grid is being used as a basis for storing data relating to a node of a communications network with a mapping to grid points of the adaptive grid; and
cause storage of an indication of the determined at least one factor for the node.

35. The apparatus according to claim 34, wherein the computer program code is further configured to, with the at least one processor, cause an apparatus to obtain the density of the adaptive grid by one of:
taking into account a configuration;
increasing a previous density of the adaptive grid by adding at least one of columns and or rows to the adaptive grid; and
reducing a previous density of the adaptive grid by removing at least one of rows and columns of the adaptive grid.

36. The apparatus according to claim 34, wherein the computer program code is configured to, with the at least one processor, cause an apparatus to determine the at least one factor at least one of
after a detected change of storage consumption;
after receipt of new data for the node; and
after receipt of a predetermined amount of new data.

37. The apparatus according to claim 34, wherein the computer program code is further configured to, with the at least one processor, cause an apparatus to determine the at least one factor based on at least one of the current storage consumption and an indication in a configuration.

38. The apparatus according to claim 34, wherein the at least one factor comprises at least one hop factor, which defines at least one of the number of rows of the reference grid per row of the adaptive grid and the number of columns of the reference grid per column of the adaptive grid.

39. The apparatus according to claim 38, wherein the at least one hop factor is a power of two.

40. The apparatus according to claim 34, wherein the computer program code is further configured to, with the at least one processor, cause an apparatus to align the adaptive grid with the reference grid based on the selected at least one factor.

41. The apparatus according to claim 34, wherein the computer program code is further configured to, with the at least one processor, cause an apparatus to receive data for the node and to store the received data with a mapping to grid points of the adaptive grid, taking account of the determined factor.

42. The apparatus according to claim 34, wherein the computer program code is further configured to, with the at least one processor, cause an apparatus to retrieve data that is stored for the node with a mapping to grid points of the adaptive grid, and to process the data taking account of the determined factor.

43. The apparatus according to claim 34, wherein the apparatus is one of:
a server;
a component for a server;
a mobile terminal; and
a component for a mobile terminal.

44. A non-transitory computer readable storage medium in which computer program code is stored, the computer program code when executed by a processor causing an apparatus to perform the following:
determining at least one factor defining a density of an adaptive grid in relation to a density of a reference grid, while the adaptive grid is being used as a basis for storing data relating to a node of a communications network with a mapping to grid points of the adaptive grid; and
causing storage of an indication of the determined at least one factor for the node.
